(19) United States
(12) Patent Application Publication
(10) Pub. No.: US 2014/0153526 A1
(43) Pub. Date: Jun. 5, 2014

(54) METHOD AND APPARATUS FOR CHANNEL MEASUREMENTS FOR COORDINATED MULTIPOINT TRANSMISSION

(71) Applicant: HUAWEI TECHNOLOGIES CO., LTD., Shenzhen (CN)

(72) Inventor: David MAZZARESE, Beijing (CN)

(73) Assignee: HUAWEI TECHNOLOGIES CO., LTD., Shenzhen (CN)

(21) Appl. No.: 14/176,222

(22) Filed: Feb. 10, 2014

Related U.S. Application Data
(63) Continuation of application No. PCT/CN2011/078103, filed on Aug. 8, 2011.

(51) Int. Cl. H04B 7/02; H04B 7/06

(52) U.S. Cl. CPC H04B 7/024; H04B 7/0626
USPC 370/329

(57) ABSTRACT

The present invention relates to a method for configuring reference signals and measurement sets to support coordinated multipoint transmission with distributed antennas. A first set of reference signal patterns is used for measuring and reporting received signal power from different transmission points, and a second set of reference signal patterns is used for measuring and reporting channel state information from different transmission points. The method allows to minimize power consumption and feedback overhead, while still being flexible in the configuration and re-configuration of the measurement sets.

### CROSS-REFERENCE TO RELATED APPLICATIONS

This application is a continuation of International Patent Application No. PCT/CN2011/078103, filed on Aug. 8, 2011, which is hereby incorporated by reference in its entirety.

### FIELD OF THE INVENTION

The present invention relates to communication technology and in particular to a method and apparatus for channel measurements for coordinated multipoint transmission.

### BACKGROUND OF THE INVENTION

In Multiple Input Multiple Output (MIMO) Orthogonal Frequency Division Multiple Access (OFDMA) cellular systems, closed-loop precoding is defined to enable high throughput downlink transmission to fixed and nomadic users. Channel state information (CSI) is obtained by the transmitter via a feedback report from a receiver. This CSI is used by the transmitter to derive a downlink precoder. In conventional systems, the CSI corresponds to the channel between the set of co-located antennas at the transmitter and the set of co-located antennas at the receiver. A channel state information reference signal (CSI-RS) is sent from each antenna at the transmitter. These CSI-RS are used at the receiver for measuring the channel and deriving the CSI. In order to allow the receiver to obtain an estimate of the channel for each transmit antenna, CSI-RS sent from different antennas are orthogonally separated by one or a combination of time domain multiplexing, frequency domain multiplexing and code domain multiplexing.

In cellular systems, one set of co-located transmit antennas corresponds to one transmission point, such that all the transmit antennas of the transmission point appear to a receiver as controlled by a single control entity. In conventional cellular systems, one transmission point corresponds to a serving cell for a given receiver. Different transmission points produce independent precoders intended for different receivers, and therefore interfere with each other at any receiver. The data transmitted by different transmission points interfere with each other. The reference signals transmitted by different transmission points interfere with each other. In order to mitigate the interference on CSI-RS, the CSI-RS transmitted from different transmission points are generally positioned in orthogonal resource elements and no data is transmitted from a transmission point on the resource elements occupied by the CSI-RS of another transmission point. This is shown in FIG. 1, which illustrates the CSI-RS patterns of the Long Term Evolution (LTE) Release 10 system. As shown in FIG. 1, the CSI-RS patterns indexings (i.e., Resource_Config) are for 8, 4 and 2 antennas ports (from top to bottom) in LTE Release 10. Horizontal axis is time (i.e., OFDM symbols), Vertical axis is frequency (i.e., subcarriers).

In order to avoid interference from data on the CSI-RS, the data symbols cannot be mapped to resource elements that are occupied by the CSI-RS of the serving transmission point and by the CSI-RS of other transmission points. Therefore, a receiver must be signalled the location of all the CSI-RS of all transmission points that are coordinated for interference avoidance on CSI-RS. These patterns are the CSI-RS pattern of the serving transmission point (i.e., non-zero power CSI-RS pattern), and one or more CSI-RS patterns corresponding to the CSI-RS of other transmission points (i.e., zero-power CSI-RS patterns), where transmission power is with respect to the serving transmission point. In LTE Release 10, one non-zero power CSI-RS pattern can represent 1, 2, 4 or 8 antenna ports. One zero-power CSI-RS pattern represents 4 antenna ports. The non-zero power CSI-RS pattern and the zero-power CSI-RS patterns can be overlapping, in which case the non-zero power CSI-RS have priority and are transmitted by the serving transmission point. This is illustrated in FIG. 2, which shows an example of non-zero power CSI-RS patterns and zero-power CSI-RS patterns configuration in LTE Release 10.

Some control of the interference on the resource elements allocated for data can be provided in conventional systems by power control, as well as by time and frequency scheduling assignments. In more advanced systems, a more effective way to control the interference without sacrificing spectral efficiency or transmission power is to coordinate the precoders applied at different transmission points in the spatial domain. In one instance, several sets of antennas located at different transmission points can participate in a joint transmission to the same receiver with a jointly optimized precoder across all the transmit antennas of the transmission points. In another instance, the precoder at one transmission point can form a null towards a receiver, while the precoder in another transmission point can form a beam towards the same receiver. These techniques are generally called coordinated multipoint transmission. In order to enable this type of operation, the channels corresponding to several transmission points should be measured by the receiver, and the CSI for each transmission point should be reported by feedback to the transmitter (for example the serving transmission point).

In conventional cellular networks such as LTE Release 10, a UE would be signaled two sets of CSI-RS patterns by the transmitter. One set of CSI-RS patterns (hereafter “Set 1”) contains a single CSI-RS pattern since the receiver only receives data from a single transmission point (e.g. the serving cell), and another set of CSI-RS patterns (hereafter “Set 2”) may contain several CSI-RS patterns to indicate the resource elements occupied by CSI-RS transmitted by other transmission points (e.g. other cells in the network). Since Set 2 indicates which resource elements cannot be used for data symbols for any receiver, Set 2 is common for all Rel-10 receivers and advanced receivers located in the vicinity of the same transmission point. Set 2 is signaled as a list of 4 antenna ports zero-power CSI-RS patterns. Since some transmission points corresponding to resource elements occupied by these patterns may have 1, 2 or 8 antenna ports instead of 4, the receiver does not know the actual number of antenna ports at each transmission point.

In more advanced systems, there is a need for efficient channel measurements to support coordinated multipoint transmission.

### SUMMARY OF THE INVENTION

One aspect of the present invention provides a method for channel measurements for coordinated multipoint transmission in a wireless communication system. The method includes the steps of obtaining, by the receiver, a first set of CSI-RS and a second set of CSI-RS from a transmitter; deriving, by the receiver, at least one value of CSI based on the first set of CSI-RS; deriving, by the receiver, at least one value of CSI reference signal received power (CSI-RSRP) based on the second set of CSI-RS; and sending, by the receiver, the at least one value of CSI and the at least one value of CSI-RSRP to the transmitter.

Another aspect of the present invention provides a method for channel measurements for coordinated multipoint transmission in a wireless communication system. The method includes the steps of obtaining, by the receiver, a first set of CSI-RS and a second set of CSI-RS from a transmitter; deriving, by the receiver, at least one value of CSI based on the first set of CSI-RS; deriving, by the receiver, at least one value of radio resource management (RRM) measurements based on the first set of CSI-RS and the second set of CSI-RS; sending, by the receiver, the at least one value of CSI to the transmitter; and sending, by the receiver, the at least one value of RRM measurements to the transmitter.

Still another aspect of the present invention provides a method for channel measurements for coordinated multipoint transmission in a wireless communication system. The method includes the steps of sending, by a transmitter, a first set of CSI-RS according to a first set of CSI-RS patterns and a second set of CSI-RS according to a second set of CSI-RS patterns, to a receiver; receiving, by the transmitter, at least one value of CSI derived by the receiver based on the first set of CSI-RS; receiving, by the transmitter, at least one value of CSI-RSRP derived by the receiver based on the second set of CSI-RS; determining, by the transmitter, based on the at least one value of CSI, a precoder for precoding data; and configuring, by the transmitter, the first set of CSI-RS patterns based on the at least one value of CSI-RSRP.

Still another aspect of the present invention provides a method for channel measurements for coordinated multipoint transmission in a wireless communication system. The method includes the steps of sending, by a transmitter, a first set of CSI-RS according to a first set of CSI-RS patterns and a second set of CSI-RS according to a second set of CSI-RS patterns, to a receiver; receiving, by the transmitter, at least one value of CSI derived by the receiver based on the first set of CSI-RS; receiving, by the transmitter, at least one value of RRM measurements derived by the receiver based on the first set of CSI-RS and the second set of CSI-RS; determining, by the transmitter, based on the at least one value of CSI, a precoder for precoding data; and configuring, by the transmitter, the first set of CSI-RS patterns based on the at least one value of RRM measurements.

Still another aspect of the present invention provides a receiver for channel measurements for coordinated multipoint transmission in a wireless communication system. The receiver includes: means for obtaining a first set of CSI-RS and a second set of CSI-RS from a transmitter; means for deriving at least one value of CSI based on the first set of CSI-RS; means for deriving at least one value of CSI-RSRP based on the second set of CSI-RS; and means for sending the at least one value of CSI and the at least one value of CSI-RSRP to the transmitter.

Still another aspect of the present invention provides a receiver for channel measurements for coordinated multipoint transmission in a wireless communication system. The receiver includes: means for obtaining a first set of CSI-RS and a second set of CSI-RS from a transmitter; means for deriving at least one value of CSI based on the first set of CSI-RS; means for deriving at least one value of RRM measurements based on first set of CSI-RS and the second set of CSI-RS; means for sending the at least one value of CSI to the transmitter; and means for sending the at least one value of RRM measurements to the transmitter.

Still another aspect of the present invention provides a transmitter for channel measurements for coordinated multipoint transmission in a wireless communication system. The transmitter includes: means for sending a first set of CSI-RS according to a first set of CSI-RS patterns and a second set of CSI-RS according to a second set of CSI-RS patterns, to a receiver; means for receiving at least one value of CSI derived by the receiver based on the first set of CSI-RS; means for receiving at least one value of CSI-RSRP derived by the receiver based on the second set of CSI-RS; means for determining a precoder for precoding data based on the at least one value of CSI; and means for configuring the first set of CSI-RS patterns based on the at least one value of CSI-RSRP or the at least one value of RSS.

Still another aspect of the present invention provides a transmitter for channel measurements for coordinated multipoint transmission in a wireless communication system. The transmitter includes: means for sending a first set of CSI-RS according to a first set of CSI-RS patterns and a second set of CSI-RS according to a second set of CSI-RS patterns, to a receiver; means for receiving at least one value of CSI derived by the receiver based on the first set of CSI-RS; means for receiving at least one value of RRM measurements derived by the receiver based on the first set of CSI-RS and the second set of CSI-RS; means for determining a precoder for precoding data based on the at least one value of CSI; and means for configuring the first set of CSI-RS patterns based on the at least one value of RRM measurements.

Thus, channel measurements are efficiently performed to support coordinated multipoint transmission.

### BRIEF DESCRIPTION OF THE DRAWINGS

FIG. 1 shows CSI-RS patterns indexing for 8, 4 and 2 antennas ports in LTE;

FIG. 2 shows an example of CSI-RS patterns configuration in LTE;

FIG. 3 shows a schematic flowchart of a method for channel measurements in an embodiment of the present invention;

FIG. 4 shows a schematic flowchart of a method for channel measurements in another embodiment of the present invention;

FIG. 5 shows a schematic flowchart of a method for channel measurements in still another embodiment of the present invention;

FIG. 6 shows a schematic flowchart of a method for channel measurements in still another embodiment of the present invention;

FIG. 7 shows a schematic flowchart of a method for channel measurements in still another embodiment of the present invention.

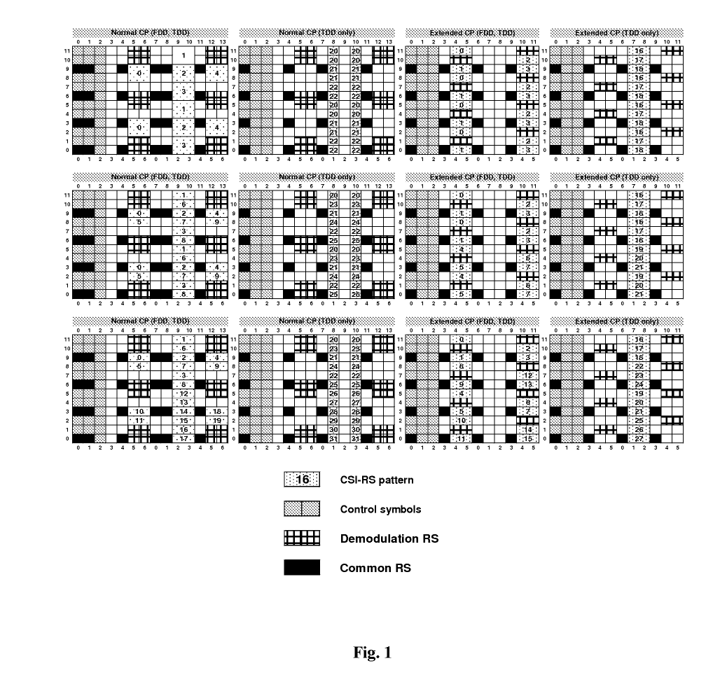

### DETAILED DESCRIPTION OF THE EMBODIMENTS

Embodiments of the present invention relates to a method and apparatus for channel measurements to support coordinated multipoint transmission. Embodiments of the present invention may be applied to a wireless communication system, such as a LTE advanced system. The wireless communication system may include one or more transmitters and one or more receivers. A person skilled in the art knows that the transmitter may be but not limited to a base station, such as an Evolved UMTS Terrestrial Radio Access Network Node B (ENB); the receiver may be but not limited to a user equipment (UE).

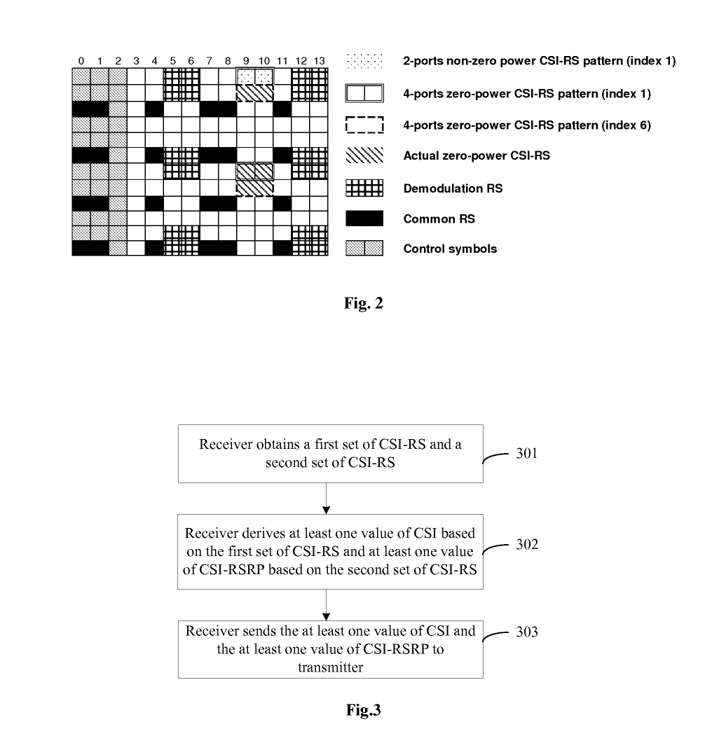

FIG. 3 shows a schematic flowchart of a method for channel measurements for coordinated multipoint transmission in a wireless communication system according to one embodiment of the present invention. As shown in FIG. 3, in the method, a receiver obtains a first set of CSI-RS and a second set of CSI-RS from a transmitter in step 301. Then, the receiver derives at least one value of CSI based on the first set of CSI-RS, and at least one value of CSI-RS receiver power (CSI-RSRP) based on the second set of CSI-RS in step 302. Then, the receiver sends the at least one value of CSI and the at least one value of CSI-RSRP to the transmitter in step 303.

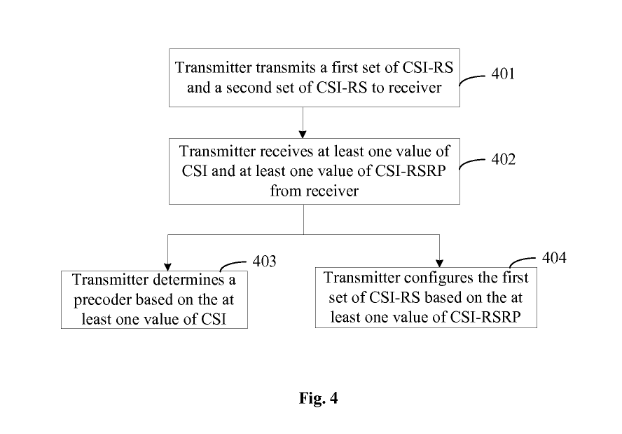

At the transmitter side, corresponding operations are implemented which are shown in FIG. 4. The transmitter sends the first set of CSI-RS and the second set of CSI-RS to the receiver in step 401. Then, the transmitter receives the at least one value of CSI derived by the receiver based on the first set of CSI-RS, and the at least one value of CSI-RSRP derived by the receiver based on the second set of CSI-RS in step 402. Then, the transmitter can efficiently determine a precoder for precoding data based on the at least one value of CSI in step 403, and configuring or updating the first set of CSI-RS based on the at least one value of CSI-RSRP in step 404.

Additionally, the transmitter may sends configuration of a first set of CSI-RS patterns and a second set of CSI-RS patterns to the receiver, then the transmitter sends the first set of CSI-RS according to the first set of CSI-RS pattern and the second set of CSI-RS according to the second set of CSI-RS pattern. Then, the receiver can obtain the first set of CSI-RS and the second set of CSI-RS according to the configuration.

In another embodiment, the at least one value of CSI-RSRP may be derived based on the first set of CSI-RS and the second set of CSI-RS, and the receiver derive received signal strength (RSS) or Reference Signal Receiving Quality (RSRQ) besides CSI-RSRP.

In still another embodiment, a transmitter sends configuration of K (K≧1) CSI-RS patterns. Each CSI-RS pattern may be associated with a CSI measurements flag. For each CSI-RS pattern, the CSI measurements flag in the configuration may take value 0 or 1. If the CSI measurements flag is equal to 1, the UE is expected to take CSI measurements based on this CSI-RS pattern. Additional signalling may configure feedback reports of CSI with a certain period.

The configuration may be additionally associated with the following parameters: the number of antenna ports, time-frequency position, periodicity and scrambling sequence. The parameters of the number of antenna ports, the time-frequency position and the periodicity are used by the receiver for determining the time-frequency position of the CSI-RS. The scrambling sequence is used by the receiver for descrambling the received CSI-RS. Each CSI-RS pattern may be additionally associated a power offset, such as energy per resource element (EPRE) offset.

In this embodiment, the UE is expected to take radio resource management (RRM) measurements of CSI-RS receiver power (CSI-RSRP) for each CSI-RS pattern. That is to say, all CSI-RS patterns are used for measuring CSI-RSRP, irrespective of the values of the CSI measurements flag. Additional signalling may configure feedback reports of CSI-RSRP with a certain period. Additionally, all CSI-RS patterns are used for rate matching Physical Downlink Shared Channel (PDSCH) around the REs occupied by the CSI-RS, irrespective of the values of the CSI measurements flag.

In one example, all CSI-RS patterns sent to the receiver may define Set 1 and the set of CSI-RS patterns with the CSI measurements flag set to 1 defines Set 3. In summary, 3 sets of CSI-RS patterns may be identified by the following values of the flags:
Set 1: All CSI-RS patterns
Set 2: CSI-RS patterns for which CSI measurements flag take value 0
Set 3: CSI-RS patterns for which CSI measurements flag take value 1

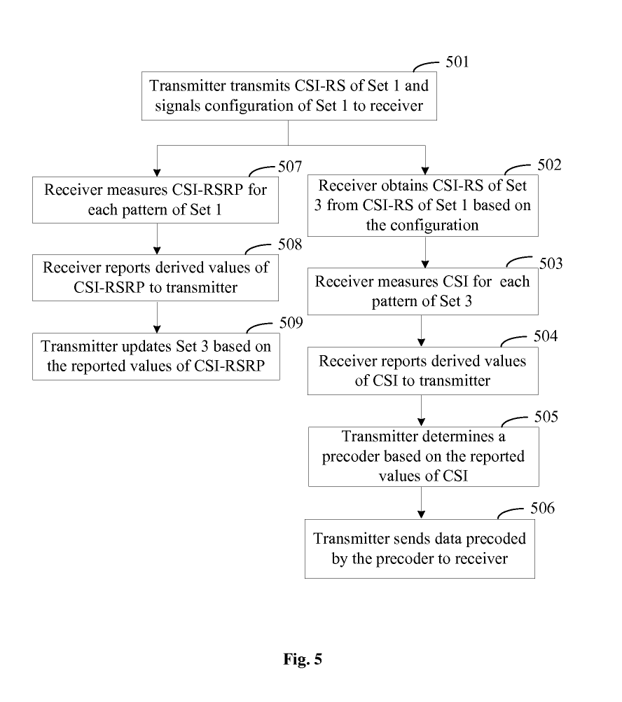

FIG. 5 illustrates a schematic flowchart of a method for channel measurements based on the definition of 3 sets of CSI-RS patterns aforementioned. As shown in FIG. 5, in the method, the transmitter transmits CSI-RS of Set 1 and signal configuration of Set 1 in step 501. In step 501, the transmitter transmits CSI-RS according to CSI-RS patterns of Set 1, and the configuration of Set 1 may include a CSI measurement flag for each CSI-RS pattern. When the CSI measurements flag is equal to 1, the UE is expected to take CSI measurements. A skilled person knows that signalling of the configuration and transmission of the CSI-RS may be sent separately and the signalling of the configuration of the CSI-RS patterns may occur before the transmission of the CSI-RS in practice. Then, the receiver obtains CSI-RS of Set 3 from CSI-RS of Set 1 based on the configuration in step 502; then the receiver measures CSI for each CSI-RS pattern of Set 3 to derive K values of CSI in step 503; and then reports the derived K values of CSI to the transmitter in step 504. Therefore, the transmitter can determine a precoder based on the reported K values of CSI in step 505, and transmits data which is precoded by the determined precoder to the receiver in step 506.

Additionally, all of the received CSI-RS of Set 1 may be used for taking RRM measurements. To implement this operation, the method may further include: the receiver measures CSI-RSRP for each CSI-RS pattern of Set 1 to derive K values of CSI-RSRP in step 507, and then reports the derived K values of CSI-RSRP to the transmitter in step 508. Therefore, the transmitter can configure or update Set 3 based on the reported K values of CSI-RSRP in step 509.

Therefore, the configuring or updating process provided by reporting CSI-RSRP for CSI-RS of Set 1 enables to minimize the feedback overhead, and by selecting only the transmission points for which the received signal power is large enough to provide some benefit in the coordinated multipoint transmission, thus only these transmission points may be included in Set 3.

In still another embodiment, a transmitter signals configuration of K (K≧1) CSI-RS patterns to a receiver. Each CSI-RS pattern may be associated with a CSI measurements flag and a RRM measurements flag. For each CSI-RS pattern, the RRM measurements flag takes value 0 or 1. If the RRM measurements flag is equal to 1, the UE is expected to take RRM measurements of CSI-RSRP. For each CSI-RS pattern, the CSI measurements flag takes value 0 or 1. If the CSI measurements flag is equal to 1, the UE is expected to take CSI measurements. Additional signalling may configure feedback reports of CSI-RSRP with a certain period. Additional signalling may configure feedback reports of CSI with a certain period.

In one example, the set of CSI-RS patterns with the RRM measurements flag set to 1 define Set 1, and the set of CSI-RS patterns with the CSI measurements flag set to 1 define Set 3. In summary, 3 sets of CSI-RS patterns can be identified by the following values of the flags:
Set 1: CSI-RS patterns for which RRM measurements flag takes value 1
Set 2: CSI-RS patterns for which CSI and RRM measurements flags take value 0
Set 3: CSI-RS patterns for which CSI measurements flag takes value 1

The configuration may be additionally associated with the following parameters: the number of antenna ports, time-frequency position, periodicity and scrambling sequence. Each CSI-RS pattern may be additionally associated a power offset, such as EPRE offset. An example of the configuration for all of the CSI-RS patterns sent to the receiver is illustrated in the following Table 1.

TABLE 1

| | Antenna | | | | CSI | RRM |
|---|---|---|---|---|---|---|
| Resource | Ports | Subframe | Sequence | EPRE | measurements | measurements |
| Config | Count | Config | ID | offset | flag | flag |
| 1 | 2 | 1 | 0 | 2 dB | 1 | 1 |
| 6 | 2 | 1 | 1 | 2 dB | 1 | 1 |
| 2 | 2 | 1 | 2 | 4 dB | 1 | 1 |
| 7 | 2 | 1 | 30 | 6 dB | 0 | 1 |
| 3 | 2 | 1 | 31 | 4 dB | 0 | 1 |
| 8 | 2 | 1 | 32 | 2 dB | 0 | 1 |
| 12 | 2 | 1 | 60 | 4 dB | 0 | 1 |
| 13 | 2 | 1 | 61 | 6 dB | 0 | 1 |
| 14 | 2 | 1 | 62 | 4 dB | 0 | 1 |
| 15 | 2 | 1 | n.a. | 2 dB | 0 | 0 |
| 16 | 2 | 1 | n.a. | 4 dB | 0 | 0 |
| 17 | 2 | 1 | n.a. | 6 dB | 0 | 0 |

In Table 1, “Resource Config” indicates the time-frequency position; “Antenna Ports Count” indicates the number of antenna ports, “Subframe Config” indicates the periodicity; “Sequence ID” indicates the scrambling sequence. It should be noted that some parameters may be common to all the CSI-RS patterns in Table 1 and thus signalled only once for all the patterns, such as the “Subframe Config”.

In this embodiment, all CSI-RS patterns are used for rate matching the PDSCH around the REs occupied by these CSI-RS, irrespective of the values of the two flags. A CSI-RS pattern for which RRM measurements flag and CSI measurements flag are set to 0 is only used for rate matching the PDSCH around the REs occupied by the CSI-RS. Depending on the values of the RRM measurements flags and the CSI measurements flags, each CSI-RS pattern may be used also for CSI measurements and for CSI-RSRP measurements.

Alternatively, the configuration of set of CSI-RS patterns with CSI measurements flag set to 1 may be signalled and updated independently of other parameters. This enables to update the CSI measurements flag without resending the entire configuration about the CSI-RS patterns. The same principle can be used for the RRM measurements flag. One way of achieving this is by sending toggling information relative to the CSI or RRM measurements flag for a CSI-RS pattern.

Alternatively, the set of CSI-RS patterns with RRM measurements flag set to 1 is a superset of the set of CSI-RS patterns with CSI measurements flag set to 1. The configuration of CSI measurements flag may be signalled and updated independently of other parameters, with reduced signalling overhead by signalling only the CSI-RS patterns that already belong to the RRM measurements set (i.e., Set 1).

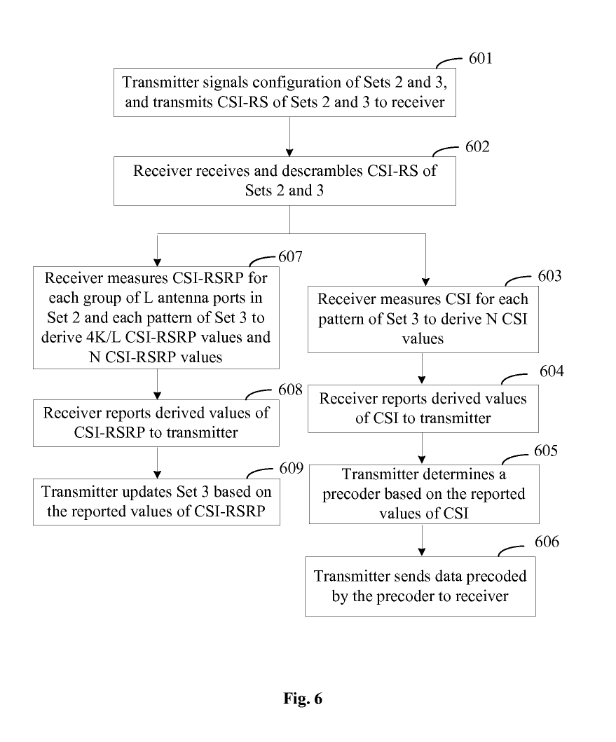

FIG. 6 illustrates a schematic flowchart of a method for channel measurements for coordinated multipoint transmission in a wireless communication system according to another embodiment of the present invention. In this embodiment, the coordination area for multiple transmission points in the wireless communication system is configured such that all the transmission points share a common cell identity. A person skilled in the art knows that a receiver may obtain the common cell identity in the procedure of entering the cellular system. This cell identity is used to derive a scrambling sequence for each CSI-RS pattern. For example in LTE, the cell identity is used to initialize a pseudo-random sequence generator at the start of each OFDM symbol. The initial value of the pseudo-random sequence generator is computed as cᵢₙᵢₜ=2¹⁰·(7·(nₛ+1)+l+1)·(2·N_{ID}^{cell}+1)+2·N_{ID}^{cell}+N_{CP}, where N_{ID}^{cell} is the cell identity, N_{CP} is equal to 0 or 1, nₛ is the slot number within a radio frame, and l is the OFDM symbol number within the slot, respectively. Different cell identities thus allow to derive different scrambling sequences. In general, the cell identity and associated scrambling sequence is known by the receiver independently of the signalling configuration of CSI-RS patterns. Thus the cell identity and the scrambling sequence can but do not need to be informed explicitly along with the CSI-RS patterns configuration.

In this embodiment, 3 sets of CSI-RS patterns can be defined as:
Set 1: the union of Set 2 and Set 3
Set 2: the set of zero-power CSI-RS patterns
Set 3: the set of non-zero power CSI-RS patterns

Therefore, a transmitter signals configuration of K zero-power CSI-RS patterns (K≧1) with 4 antenna ports each, and N non-zero power CSI-RS patterns (N≧1) (the configuration of Sets 2 and 3) in step 601. The transmitter also transmits zero-power CSI-RS according to the K zero-power CSI-RS patterns, and transmits non-zero power CSI-RS according to the N non-zero power CSI-RS patterns in step 601. A skilled person in the art knows that CSI-RS of zero-power CSI-RS patterns have zero power, so the transmitter simply doesn't transmit anything for the CSI-RS of K zero-power CSI-RS patterns. Furthermore, signalling of the configuration and transmission of the CSI-RS may be sent separately and the signalling of the configuration of the CSI-RS patterns may occur before the transmission of the CSI-RS in practice.

In this embodiment, the transmitter signals a parameter L, which indicates the assumption used by the receiver about the number of antenna ports at each transmission point sending CSI-RS among the K zero-power CSI-RS patterns. The transmitter and the receiver may derive a common list of 4K/L groups of L antenna ports based on the signalled K zero-power CSI-RS patterns and the parameter L.

Additionally, each of the N non-zero power CSI-RS patterns may be associated with the following parameters in the configuration: the number of antenna ports, time-frequency position, and periodicity. Each of the K zero power CSI-RS patterns may be associated with the following parameters: time-frequency position and periodicity.

The receiver receives the non-zero power CSI-RS (i.e., CSI-RS of Set 3) and de-scrambles the received non-zero power CSI-RS using the scrambling sequence in step 602, and then measures CSI for each of the non-zero power CSI-RS patterns to derive N CSI values in step 603, and then reports the N CSI values by feedback to the transmitter in step 604. Therefore, the transmitter can determine a precoder based on the received N CSI values in step 605, and transmit data precoded by the precoder to the receiver in step 606.

Additionally, the receiver receives the zero-power CSI-RS (i.e., CSI-RS of Set 2) and de-scrambles the received zero-power CSI-RS using the scrambling sequence in step 602, then the receiver takes RRM measurements, for example measures CSI-RSRP for each group of L antenna ports to derive 4K/L CSI-RSRP values in step 607, and then reports the 4K/L CSI-RSRP values by feedback to the transmitter in step 608. With similar means, the receiver measures CSI-RSRP for each non-zero power CSI-RS to derive N CSI-RSRP values in step 607, and then reports N CSI-RSRP values by feedback to the transmitter in step 608. Therefore, the transmitter can configure or update the non-zero CSI-RS patterns according to the CSI-RSRP values reported by the receiver in step 609, for example by selecting the transmission points with the largest CSI-RSRP.

Even though some transmission point corresponding to zero-power CSI-RS patterns may have more than L antenna ports, the UE only needs to measure the CSI-RSRP of groups of L antenna ports without knowledge of the actual number of ports at each transmission point, and independently of the configuration of non-zero CSI-RS patterns. Note that in practice, L is larger than the minimum number of antenna ports at any transmission point corresponding to any antenna port within the zero-power CSI-RS patterns.

In another embodiment, the set of non-zero power CSI-RS patterns and the set of zero-power CSI-RS patterns occupy orthogonal resource elements. This type of configuration allows avoiding redundancy in the CSI-RSRP measurements and feedback reports, since no two reports will correspond to the same antenna port.

In another embodiment, the set of non-zero power CSI-RS patterns is a subset of the set of zero-power CSI-RS patterns. So the receiver only needs to report the CSI-RSRP of the K/L groups of L ports for the set of zero-power CSI-RS patterns, and does not need to report the CSI-RSRP of the N non-zero power CSI-RS patterns. Therefore the configurations of CSI measurements and CSI-RSRP measurements can be set independently, and thus reduce the transmitter and receiver implementation complexity.

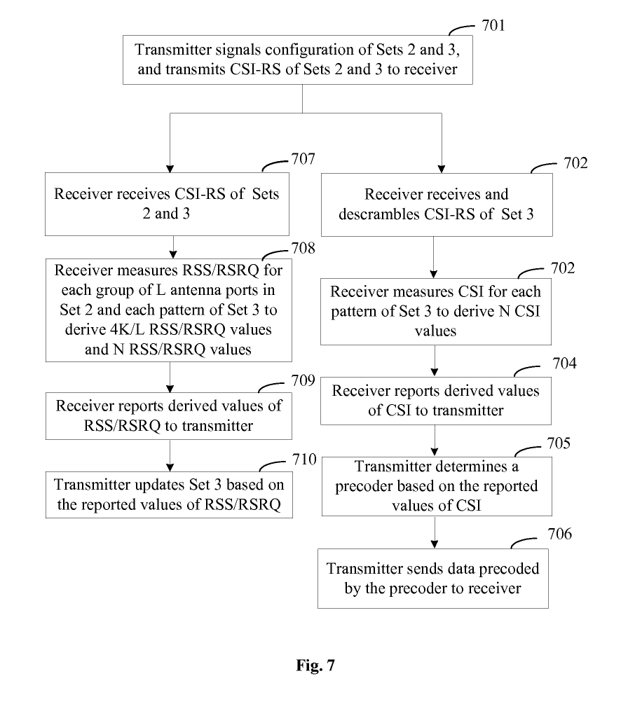

FIG. 7 illustrates a schematic flowchart of a method for channel measurements for coordinated multipoint transmission in a wireless communication system according to another embodiment of the present invention. In this embodiment, 3 sets of CSI-RS patterns can be identified as:
Set 1: the union of Set 2 and Set 3
Set 2: the set of zero-power CSI-RS patterns
Set 3: the set of non-zero power CSI-RS patterns

In this embodiment, the receiver does not make any assumption on the scrambling sequences applied to the zero-power CSI-RS patterns. As shown in FIG. 7, a transmitter signals configuration of K zero-power CSI-RS patterns with 4 antenna ports each, and N non-zero power CSI-RS patterns (i.e., the configuration of Sets 2 and 3) in step 701. The transmitter also transmits K zero-power CSI-RS according to the K zero-power CSI-RS patterns, and N non-zero power CSI-RS according to the N non-zero power CSI-RS patterns (i.e., CSI-RS of Sets 2 and 3) in step 701. A skilled person in the art knows that RS of zero-power CSI-RS patterns have zero power, so the transmitter simply doesn't transmit anything for the CSI-RS of K zero-power CSI-RS patterns. Furthermore, signalling of the configuration and transmission of the CSI-RS may be sent separately and the signalling of the configuration of the CSI-RS patterns may occur before the transmission of the CSI-RS in practice.

In this embodiment, the transmitter signals a parameter L, which indicates the assumption used by the receiver about the number of antenna ports at each transmission point transmitting CSI-RS among the K zero-power CSI-RS patterns. The transmitter and the receiver derive a common list of 4K/L groups of L antenna ports based on the signalled zero-power CSI-RS patterns and the parameter L.

Additionally, each of the N non-zero power CSI-RS patterns is associated with the following parameters: the number of antenna ports, time-frequency position, and periodicity. Each of the K zero power CSI-RS patterns are associated with the following parameters: a time-frequency position, and a periodicity.

The receiver receives the non-zero power CSI-RS (i.e., CSI-RS of Set 3) and de-scrambles the received non-zero power CSI-RS using the scrambling sequences in step 702, then the receiver takes RRM measurements, for example measures CSI for each of the non-zero power CSI-RS patterns to derive N CSI values in step 703, and then reports N CSI values by feedback to the transmitter in step 704. Therefore, the transmitter can determine a precoder based on the received N CSI in step 705, and transmit data precoded by the precoder to the receiver in step 706.

Additionally, the receiver receives the zero-power CSI-RS in step 707, and measures RSS or reference signal receive quality (RSRQ) for each group of L antenna ports to derive 4K/L RSS values in step 708, and then reports the 4K/L RSS values or 4K/L RSRQ values by feedback to the transmitter in step 709. Skilled person knows that the RSS values may be represented by received signal strength indicator (RSSI) values. With similar means, the receiver receives the non-zero power CSI-RS in step 707, and measures RSS or RSRQ for each of the non-zero power CSI-RS patterns to derive N RSS or N RSRQ values in step 708, and then reports the N RSS or N RSRQ values by feedback to the transmitter in step 709. Therefore, the transmitter can configure or update the non-zero CSI-RS patterns according to the RSS or RSRQ values reported by the receiver in step 710, for example by selecting the transmission points with the largest RSS.

Even though each transmission point corresponding to zero-power CSI-RS patterns may have more than L antenna ports, the UE only needs to measure the RSSI for groups of L antenna ports independently without knowledge of the actual number of ports at each transmission point and without knowledge of the scrambling sequences applied to the CSI-RS ports, and independently of the configuration of non-zero CSI-RS patterns. Note that in practice, L is larger than the minimum number of antenna ports at any transmission point corresponding to any antenna port within the zero-power CSI-RS patterns. In systems where orthogonal CSI-RS patterns are assigned to different transmission points belonging to the same coordination area, such that orthogonality is achieved in the time or frequency domain, RSS measurements provide accurate statistics for the selection of the transmission points that offer the largest signal strength, since the interference coming from transmission points outside the coordination area would contribution a relatively low average power on the resource elements occupied by the CSI-RS of the transmission points that belong to the coordination area.

In another embodiment, the set of non-zero power CSI-RS patterns and the set of zero-power CSI-RS patterns occupy orthogonal resource elements. This type of configuration allows avoiding redundancy in the RSS measurements and feedback reports, since no two reports will correspond to the same antenna port.

In another embodiment, the set of non-zero power CSI-RS patterns is a subset of the set of zero-power CSI-RS patterns. So the receiver only needs to report the RSS of the K/L groups of L ports in the set of zero-power CSI-RS patterns, and does not need to report the RSS of the N non-zero power CSI-RS patterns. Therefore the configurations of CSI measurements and RSS measurements can be set independently, and thus reduce the transmitter and receiver implementation complexity.

All functional units in the embodiments of the present invention may be integrated into a processing module, or exist independently, or two or more of such units are integrated into a module. The integrated module may be hardware or a software module. When being implemented as a software module and sold or applied as an independent product, the integrated module may also be stored in a computer-readable storage medium. The storage medium may be a Read-Only Memory (ROM), magnetic disk or Compact Disk (CD).

Elaborated above are a media content transmission method and a network-side equipment under the present invention. Although the invention is described through some exemplary embodiments, the invention is not limited to such embodiments. It is apparent that those skilled in the art can make modifications and variations to the invention without departing from the scope of the invention. The invention is intended to cover the modifications and variations provided that they fall in the scope of protection defined by the following claims or their equivalents.

Further embodiments of the present invention are provided as follows:

1. A method for channel measurements for coordinated multipoint transmission in a wireless communication system, including:

obtaining, by a receiver, a first set of channel state information reference signals (CSI-RS) and a second set of CSI-RS from a transmitter;

deriving, by the receiver, at least one value of channel state information (CSI) based on the first set of CSI-RS;

deriving, by the receiver, at least one value of CSI reference signal received power (CSI-RSRP) based on the second set of CSI-RS; and

sending, by the receiver, the at least one value of CSI and the at least one value of CSI-RSRP to the transmitter.

2. The method of embodiment 1, where the obtaining, by the receiver, the first set of CSI-RS and the second set of CSI-RS from the transmitter includes:

receiving, by the receiver, configuration of at least one CSI-RS pattern from the transmitter;

receiving, by the receiver, at least one CSI-RS transmitted by the transmitter according to the at least one CSI-RS pattern; and

obtaining, by the receiver, the first set of CSI-RS and the second set of CSI-RS from the received at least one CSI-RS according to the configuration.

3. The method of embodiment 2, where

the configuration includes a CSI measurements flag for each CSI-RS pattern; and

the first set of CSI-RS includes a first set of CSI-RS patterns for which the CSI measurements flag takes value 1; the second set of CSI-RS includes a second set of CSI-RS patterns for which the CSI measurements flag takes value 1 and value 0.

4. The method of embodiment 3, where

the CSI measurements flag with value 1 indicates that the receiver takes CSI measurements.

5. The method of embodiment 2, where

the configuration includes a CSI measurement flag for each CSI-RS pattern and a radio resource management (RRM) flag for each CSI-RS pattern; and

the first set of CSI-RS includes a first set of CSI-RS patterns for which the CSI measurement flag takes value 1; the second set of CSI-RS includes a second set of CSI-RS patterns for which the RRM flag takes value 1.

6. The method of embodiment 5, where

the CSI measurements flag with value 1 indicates that the receiver takes CSI measurements; and

the RRM measurement flag with value 1 indicates that the receiver takes RRM measurements of CSI-RSRP.

7. The method of embodiment 5 or 6, further including:

obtaining, by the receiver, a third set of CSI-RS; where

the third set of CSI-RS includes a third set of CSI-RS patterns for which the RRM measurements flag and the CSI measurements flag take value 0, and a CSI-RS of the third set of CSI-RS is used by the receiver for rate matching a physical downlink shared channel (PDSCH) around resource elements occupied by the CSI-RS of the third set of CSI-RS.

8. The method of any one of embodiments 3 to 7, where

the first set of CSI-RS patterns is a subset of the second set of CSI-RS patterns.

9. The method of any one of embodiments 3 to 8, where the at least one value of CSI-RSRP is used for configuring the first set of CSI-RS patterns by the transmitter.

10. The method of any one of embodiments 1 to 9, where

all of the obtained CSI-RS are used by the receiver for rate matching a physical downlink shared channel (PDSCH) around resource elements occupied by these CSI-RS.

11. The method of any one of embodiments 1 to 10, further including:

receiving, by the receiver, from the transmitter, data precoded by a precoder determined by the transmitter based on the at least one value of CSI.

12. A method for channel measurements for coordinated multipoint transmission in a wireless communication system, including:

obtaining, by a receiver, a first set of channel state information reference signals (CSI-RS) and a second set of CSI-RS from a transmitter;

deriving, by the receiver, at least one value of channel state information (CSI) based on the first set of CSI-RS;

deriving, by the receiver, at least one value of radio resource management (RRM) measurements based on the first set of CSI-RS and the second set of CSI-RS;

sending, by the receiver, the at least one value of CSI to the transmitter; and

sending, by the receiver, the at least one value of RRM measurements to the transmitter.

13. The method of embodiment 12, where the obtaining, by the receiver, the first set of CSI-RS and the second set of CSI-RS from the transmitter includes:

receiving, by the receiver, configuration of at least one CSI-RS pattern from the transmitter;

receiving, by the receiver, at least one CSI-RS transmitted by the transmitter according to the at least one CSI-RS pattern; and

obtaining, by the receiver, the first set of CSI-RS and the second set of CSI-RS from the received at least one CSI-RS according to the configuration.

14. The method of embodiment 13, where

the first set of CSI-RS includes a set of N non zero-power CSI-RS patterns;

the second set of CSI-RS includes a set of K zero-power CSI-RS patterns with 4 antenna ports; and

the configuration further includes a parameter L which indicates assumption used by the receiver about the number of antenna ports at each transmission point sending RS among the K zero-power CSI-RS patterns;

where K, N and L are positive integers.

15. The method of embodiment 14, where the deriving, by the receiver, the at least one value of RRM measurements based on the first set of CSI-RS and the second set of CSI-RS includes:

deriving, by the receiver, 4K/L groups of L antenna ports based on the K zero-power CSI-RS patterns and the parameter L;

measuring, by the receiver, CSI reference signal received power (CSI-RSRP) or received signal strength (RSS) or reference signal receive quality (RSRQ) for each group of L antenna ports to derive 4K/L values of CSI-RSRP or 4K/L values of RSS or 4K/L values of RSRQ; and

measuring, by the receiver, CSI-RSRP or RSS or RSRQ for each non-zero power CSI-RS patterns to derive N values of CSI-RSRP or N values of RSS or N values of RSRQ.

16. The method of embodiment 15, where the sending, by the receiver, the at least one value of RRM measurements to the transmitter includes:

sending, by the receiver, the 4K/L values of CSI-RSRP or the 4K/L values of RSS or 4K/L values of RSRQ to the transmitter; and

sending, by the receiver, the N values of CSI-RSRP or the N values of RSS or the N values of RSRQ to the transmitter.

17. The method of any one of embodiments 14 to 16, where

L is larger than the minimum number of antenna ports at any transmission point corresponding to any antenna port within the set of zero-power CSI-RS patterns.

18. The method of any one of embodiments 14 to 17, where

the set of N non-zero power CSI-RS patterns is a subset of the set of K zero-power CSI-RS patterns.

19. The method of any one of embodiments 14 to 18, where

the at least one value of RRM measurements is used for configuring the set of N non-zero power CSI-RS patterns by the transmitter.

20. The method of any one of embodiments 12 to 19, further including:

receiving, by the receiver, from the transmitter, data precoded by a precoder determined by the transmitter based on the at least one value of CSI.

21. A method for channel measurements for coordinated multipoint transmission in a wireless communication system, including:

sending, by a transmitter, a first set of channel state information reference signals (CSI-RS) according to a first set of CSI-RS patterns and a second set of CSI-RS according to a second set of CSI-RS patterns, to a receiver;

receiving, by the transmitter, at least one value of channel state information (CSI) derived by the receiver based on the first set of CSI-RS;

receiving, by the transmitter, at least one value of CSI reference signal received power (CSI-RSRP) derived by the receiver based on the second set of CSI-RS;

determining, by the transmitter, based on the at least one value of CSI, a precoder for precoding data; and

configuring, by the transmitter, the first set of CSI-RS patterns based on the at least one value of CSI-RSRP.

22. The method of embodiment 21, further including:

sending, by the transmitter, configuration of at least one CSI-RS pattern to the receiver; where the at least one CSI-RS pattern includes the first set of CSI-RS patterns and the second set of CSI-RS patterns.

23. The method of embodiment 22, where

the configuration includes a CSI measurements flag for each CSI-RS pattern; and

the first set of CSI-RS includes the first set of CSI-RS patterns for which the RLM measurements flag takes value 1; the second set of CSI-RS includes the second set of CSI-RS patterns for which the RLM measurements flag takes value 1 and value 0.

24. The method of embodiment 23, where

the CSI measurements flag with value 1 indicates that the receiver takes CSI measurements.

25. The method of embodiment 22, where

the configuration includes a CSI measurement flag for each CSI-RS pattern and a radio resource management (RRM) flag for each CSI-RS pattern; and

the first set of CSI-RS includes the first set of CSI-RS patterns for which the CSI measurement flag takes value 1; the second set of CSI-RS includes the second set of CSI-RS patterns for which the RRM flag takes value 1.

26. The method of embodiment 25, where

the CSI measurements flag with value 1 indicates that the receiver takes CSI measurements; and

the RRM measurement flag with value 1 indicates that the receiver takes RRM measurements of CSI-RSRP.

27. The method of embodiment 25 or 26, further including:

sending, by the transmitter, a third set of CSI-RS; where

the third set of CSI-RS includes a third set of CSI-RS patterns for which the RRM measurements flag and the CSI measurements flag take value 0, and a CSI-RS of the third set of CSI-RS is used by the receiver for rate matching a physical downlink shared channel (PDSCH) around resource elements occupied by the CSI-RS of the third set of CSI-RS.

28. The method of any one of embodiments 21 to 27, where

the first set of CSI-RS patterns is a subset of the second set of CSI-RS patterns.

29. The method of any one of embodiments 21 to 28, where

all of the CSI-RS sent by transmitter are used by the receiver for rate matching a physical downlink shared channel (PDSCH) around resource elements occupied by these CSI-RS.

30. A method for channel measurements for coordinated multipoint transmission in a wireless communication system, including:

sending, by a transmitter, a first set of channel state information reference signal (CSI-RS) according to a first set of CSI-RS patterns and a second set of CSI-RS according to a second set of CSI-RS patterns, to a receiver;

receiving, by the transmitter, at least one value of channel state information (CSI) derived by the receiver based on the first set of CSI-RS;

receiving, by the transmitter, at least one value of radio resource management (RRM) measurements derived by the receiver based on the first set of CSI-RS and the second set of CSI-RS;

determining, by the transmitter, based on the at least one value of CSI, a precoder for precoding data; and

configuring, by the transmitter, the first set of CSI-RS patterns based on the at least one value of RRM measurements.

31. The method of embodiment 30, further including:

sending, by the transmitter, configuration of at least one CSI-RS pattern to the receiver; where the at least one CSI-RS pattern includes the first set of CSI-RS patterns and the second set of CSI-RS patterns.

32. The method of embodiment 30 or 31, where

the first set of CSI-RS patterns is a set of N non zero-power CSI-RS patterns;

the second set of CSI-RS patterns is a set of K zero-power CSI-RS patterns with 4 antenna ports; and

the configuration further includes a parameter L which indicates assumption used by the receiver about the number of antenna ports at each transmission point sending CSI-RS among the K zero-power CSI-RS patterns;

where K, N and L are positive integers.

33. The method of embodiment 32, where

the at least one value of RRM measurements includes 4K/L values of CSI reference signal received power (CSI-RSRP) or received signal strength (RSS) or reference signal receive quality (RSRQ) derived by the receiver based on the K zero-power CSI-RS patterns and the parameter L, and N values of CSI-RSRP or RSS or RSRQ derived by the receiver based on the N non-zero power CSI-RS patterns.

34. The method of embodiment 32 or 33, where

L is larger than the minimum number of antenna ports at any transmission point corresponding to any antenna port within the set of zero-power CSI-RS patterns.

35. The method of any one of embodiments 32 to 34, where

the set of N non-zero power CSI-RS patterns is a subset of the set of K zero-power CSI-RS patterns.

36. A receiver for channel measurements for coordinated multipoint transmission in a wireless communication system, including:

means for obtaining a first set of channel state information reference signals (CSI-RS) and a second set of CSI-RS from a transmitter;
means for deriving at least one value of channel state information (CSI) based on the first set of CSI-RS;

means for deriving at least one value of CSI reference signal received power (CSI-RSRP) based on the second set of CSI-RS; and

means for sending the at least one value of CSI and the at least one value of CSI-RSRP to the transmitter.

37. The receiver of embodiment 36, where the means for obtaining the first set of CSI-RS and the second set of CSI-RS from the transmitter further includes:

means for receiving configuration of at least one CSI-RS pattern from the transmitter;

means for receiving at least one CSI-RS transmitted by the transmitter according to the at least one CSI-RS pattern; and

means for obtaining the first set of CSI-RS and the second set of CSI-RS from the received at least one CSI-RS according to the configuration.

38. The receiver of embodiment 37, where the configuration includes a CSI measurements flag for each CSI-RS pattern; and

the first set of CSI-RS includes a first set of CSI-RS patterns for which the CSI measurements flag takes value 1; the second set of CSI-RS includes a second set of CSI-RS patterns for which the CSI measurements flag takes value 1 and value 0.

39. The receiver of embodiment 38, where

the CSI measurements flag with value 1 indicates that the receiver takes CSI measurements.

40. The receiver of embodiment 37, where

the configuration includes a CSI measurement flag for each CSI-RS pattern and a radio resource management (RRM) flag for each CSI-RS pattern; and

the first set of CSI-RS includes a first set of CSI-RS patterns for which the CSI measurement flag takes value 1; the second set of CSI-RS includes a second set of CSI-RS patterns for which the RRM flag takes value 1.

41. The receiver of embodiment 40, where

the CSI measurements flag with value 1 indicates that the receiver takes CSI measurements; and

the RRM measurement flag with value 1 indicates that the receiver takes RRM measurements of CSI-RSRP.

42. The receiver of embodiment 40 or 41, further including:

means for obtaining a third set of CSI-RS; where

the third set of CSI-RS includes a third set of CSI-RS patterns for which the RRM measurements flag and the CSI measurements flag take value 0, and a CSI-RS of the third set of CSI-RS is used by the receiver for rate matching a physical downlink shared channel (PDSCH) around resource elements occupied by the CSI-RS of the third set of CSI-RS.

43. The receiver of any one of embodiments 36 to 42, where the at least one value of CSI-RSRP is used for configuring the first set of CSI-RS patterns by the transmitter.

44. The receiver of any one of embodiments 36 to 43, where

the first set of CSI-RS patterns is a subset of the second set of CSI-RS patterns.

45. The receiver of any one of embodiments 36 to 44, where

all of the obtained CSI-RS are used by the receiver for rate matching a physical downlink shared channel (PDSCH) around resource elements occupied by these CSI-RS.

46. The receiver of any one of embodiments 36 to 45, further including:

means for receiving, from the transmitter, data precoded by a precoder determined by the transmitter based on the at least one value of CSI.

47. A receiver for channel measurements for coordinated multipoint transmission in a wireless communication system, including:

means for obtaining a first set of channel state information reference signals (CSI-RS) and a second set of CSI-RS from a transmitter;

means for deriving at least one value of channel state information (CSI) based on the first set of CSI-RS;

means for deriving at least one value of radio resource management (RRM) measurements based on first set of CSI-RS and the second set of CSI-RS;

means for sending the at least one value of CSI to the transmitter; and

means for sending the at least one value of RRM measurements to the transmitter.

48. The receiver of embodiment 47, where the means for obtaining the first set of CSI-RS and the second set of CSI-RS from the transmitter further includes:

means for receiving configuration of at least one CSI-RS pattern from the transmitter;

means for receiving at least one CSI-RS transmitted by the transmitter according to the at least one CSI-RS pattern; and

means for obtaining the first set of CSI-RS and the second set of CSI-RS from the received at least one CSI-RS according to the configuration.

49. The receiver of embodiment 48, where

the first set of CSI-RS includes a set of N non zero-power CSI-RS patterns;

the second set of CSI-RS includes a set of K zero-power CSI-RS patterns with 4 antenna ports; and

the configuration further includes a parameter L which indicates assumption used by the receiver about the number of antenna ports at each transmission point sending RS among the K zero-power CSI-RS patterns;

where K, N and L are positive integers.

50. The receiver of embodiment 49, where the means for deriving the at least one value of RRM measurements based on first set of CSI-RS and the second set of CSI-RS further includes:

means for deriving 4K/L groups of L antenna ports based on the K zero-power CSI-RS patterns and the parameter L;

means for measuring CSI reference signal received power (CSI-RSRP) RSRP or received signal strength (RSS) or reference signal receive quality (RSRQ) for each group of L antenna ports to derive 4K/L values of CSI-RSRP or 4K/L values of RSS; and

means for measuring CSI-RSRP or RSS or RSRQ for each non-zero power CSI-RS patterns to derive N values of CSI-RSRP or N values of RSS or N values of RSRQ.

51. The receiver of embodiment 50, where the means for sending the at least one value of RRM measurements to the transmitter includes:

means for sending the 4K/L values of CSI-RSRP or the 4K/L values of RSS or the 4K/L values of RSRQ to the transmitter; and

means for sending the N values of CSI-RSRP or the N values of RSS or the N values of RSRQ to the transmitter.

52. The receiver of any one of embodiments 49 to 50, where

L is larger than the minimum number of antenna ports at any transmission point corresponding to any antenna port within the set of zero-power CSI-RS patterns.

53. The receiver of any one of embodiments 49 to 51, where

the set of N non-zero power CSI-RS patterns is a subset of the set of K zero-power CSI-RS patterns.

54. The receiver of any one of embodiments 47 to 52, where

the at least one value of RRM measurements is used for configuring the set of N non-zero power CSI-RS patterns by the transmitter.

55. The receiver of any one of embodiments 47 to 53, further including:

means for receiving from the transmitter, data precoded by a precoder determined by the transmitter based on the at least one value of CSI.

56. A transmitter for channel measurements for coordinated multipoint transmission in a wireless communication system, including:

means for sending a first set of channel state information reference signals (CSI-RS) according to a first set of CSI-RS patterns and a second set of CSI-RS according to a second set of CSI-RS patterns, to a receiver;

means for receiving at least one value of channel state information (CSI) derived by the receiver based on the first set of CSI-RS;

means for receiving at least one value of CSI reference signal received power (CSI-RSRP) derived by the receiver based on the second set of CSI-RS;

means for determining a precoder for precoding data based on the at least one value of CSI; and

means for configuring the first set of CSI-RS patterns based on the at least one value of CSI-RSRP or the at least one value of RSS.

57. The transmitter of embodiment 56, further including:

means for sending configuration of at least one CSI-RS pattern to the receiver; where the at least one CSI-RS pattern includes the first set of CSI-RS patterns and the second set of CSI-RS patterns.

58. The transmitter of embodiment 57, where the configuration includes a CSI measurements flag for each CSI-RS pattern;

the first set of CSI-RS includes the first set of CSI-RS patterns for which the CSI measurements flag takes value 1; and

the second set of CSI-RS includes the second set of CSI-RS patterns for which the CSI measurements flag takes value 1 and value 0.

59. The transmitter of embodiment 58, where

the CSI measurements flag with value 1 indicates that the receiver takes CSI measurements.

60. The transmitter of embodiment 57, where

the configuration includes a CSI measurement flag for each CSI-RS pattern and a radio resource management (RRM) flag for each CSI-RS pattern;

the first set of CSI-RS includes the first set of CSI-RS patterns for which the CSI measurement flag takes value 1; and

the second set of CSI-RS includes the second set of CSI-RS patterns for which the RRM flag takes value 1.

61. The transmitter of embodiment 60, where the CSI measurements flag with value 1 indicates that the receiver takes CSI measurements; and

the RRM measurement flag with value 1 indicates that the receiver takes RRM measurements of CSI-RSRP.

62. The transmitter of embodiment 60 or 61, further including:

means for sending a third set of CSI-RS; where

the third set of CSI-RS includes a third set of CSI-RS patterns for which the RRM measurements flag and the CSI measurements flag take value 0, and a CSI-RS of the third set of CSI-RS is used by the receiver for rate matching a physical downlink shared channel (PDSCH) around resource elements occupied by the CSI-RS of the third set of CSI-RS.

63. The transmitter of any one of embodiments 56 to 62, where

the first set of CSI-RS patterns is a subset of the second set of CSI-RS patterns.

64. The transmitter of any one of embodiments 56 to 63, where

all of the CSI-RS sent by transmitter are used by the receiver for rate matching a physical downlink shared channel (PDSCH) around resource elements occupied by these CSI-RS.

65. A transmitter for channel measurements for coordinated multipoint transmission in a wireless communication system, including:

means for sending a first set of channel state information reference signals (CSI-RS) according to a first set of CSI-RS patterns and a second set of CSI-RS according to a second set of CSI-RS patterns, to a receiver;

means for receiving at least one value of channel state information (CSI) derived by the receiver based on the first set of CSI-RS;

means for receiving at least one value of radio resource management (RRM) measurements derived by the receiver based on the first set of CSI-RS and the second set of CSI-RS;

means for determining a precoder for precoding data based on the at least one value of CSI; and

means for configuring the first set of CSI-RS patterns based on the at least one value of RRM measurements.

66. The transmitter of embodiment 65, further including:

means for sending configuration of at least one CSI-RS pattern to the receiver; where the at least one CSI-RS pattern includes the first set of CSI-RS patterns and the second set of CSI-RS patterns.

67. The transmitter of embodiment 66, where

the first set of CSI-RS patterns is a set of N non zero-power CSI-RS patterns;

the second set of CSI-RS patterns is a set of K zero-power CSI-RS patterns with 4 antenna ports; and

the configuration includes a parameter L which indicates assumption used by the receiver about the number of antenna ports at each transmission point sending CSI-RS among the K zero-power CSI-RS patterns;

where K, N and L are positive integers.

68. The transmitter of embodiment 67, where

the at least one value of RRM measurements includes 4K/L values of CSI reference signal received power (CSI-RSRP) or received signal strength (RSS) or reference signal receive quality (RSRQ) derived by the receiver based on the K zero-power CSI-RS patterns and the parameter L, and N values of CSI-RSRP or RSS or RSRQ derived by the receiver based on the N non-zero power CSI-RS patterns.

69. The transmitter of embodiment 67 or 68, where

L is larger than the minimum number of antenna ports at any transmission point corresponding to any antenna port within the set of zero-power CSI-RS patterns.

70. The transmitter of any one of embodiments 65 to 69, where

the set of N non-zero power CSI-RS patterns is a subset of the set of K zero-power CSI-RS patterns.

71. A wireless communication system for channel measurements for coordinated multipoint transmission, including:

a receiver according to any one of embodiments 36 to 46; and

a transmitter according to any one of embodiments 56 to 64.

72. A wireless communication system for channel measurements for coordinated multipoint transmission, including:

a receiver according to any one of embodiments 47 to 55; and

a transmitter according to any one of embodiments 65 to 70.

What is claimed is:

1. A method for channel measurements for coordinated multipoint transmission in a wireless communication system, comprising:
obtaining, by a receiver, a first set of channel state information reference signals (CSI-RS) and a second set of CSI-RS from a transmitter;
deriving, by the receiver, at least one value of channel state information (CSI) based on the first set of CSI-RS;
deriving, by the receiver, at least one value of CSI reference signal received power (CSI-RSRP) based on the second set of CSI-RS; and
sending, by the receiver, the at least one value of CSI and the at least one value of CSI-RSRP to the transmitter.

2. The method of claim 1, wherein the obtaining, by the receiver, the first set of CSI-RS and the second set of CSI-RS from the transmitter comprises:
receiving, by the receiver, configuration of at least one CSI-RS pattern from the transmitter;
receiving, by the receiver, at least one CSI-RS transmitted by the transmitter according to the at least one CSI-RS pattern; and
obtaining, by the receiver, the first set of CSI-RS and the second set of CSI-RS from the received at least one CSI-RS according to the configuration.

3. The method of claim 2, the configuration comprises a CSI measurements flag for each CSI-RS pattern; wherein
the first set of CSI-RS comprises a first set of CSI-RS patterns for which the CSI measurements flag takes value 1;
the second set of CSI-RS comprises a second set of CSI-RS patterns for which the CSI measurements flag takes value 1 and value 0; and
the CSI measurements flag with value 1 indicates that the receiver takes CSI measurements.

4. The method of claim 2, the configuration comprises a CSI measurement flag for each CSI-RS pattern and a radio resource management (RRM) flag for each CSI-RS pattern; wherein
the first set of CSI-RS comprises a first set of CSI-RS patterns for which the CSI measurement flag takes value 1;
the second set of CSI-RS comprises a second set of CSI-RS patterns for which the RRM flag takes value 1;
the CSI measurements flag with value 1 indicates that the receiver takes CSI measurements; and
the RRM measurement flag with value 1 indicates that the receiver takes RRM measurements of CSI-RSRP.

5. The method of claim 4, further comprising:
obtaining, by the receiver, a third set of CSI-RS from the transmitter; wherein
the third set of CSI-RS comprises a third set of CSI-RS patterns for which the RRM measurements flag and the CSI measurements flag take value 0; and
a CSI-RS of the third set of CSI-RS is used by the receiver for rate matching a physical downlink shared channel (PDSCH) around resource elements occupied by the CSI-RS of the third set of CSI-RS.

6. The method of claim 1, wherein
all of the obtained CSI-RS are used by the receiver for rate matching a physical downlink shared channel (PDSCH) around resource elements occupied by these CSI-RS.

7. A method for channel measurements for coordinated multipoint transmission in a wireless communication system, comprising:
sending, by a transmitter, a first set of channel state information reference signals (CSI-RS) according to a first set of CSI-RS patterns and a second set of CSI-RS according to a second set of CSI-RS patterns, to a receiver;
receiving, by the transmitter, at least one value of channel state information (CSI) derived by the receiver based on the first set of CSI-RS;
receiving, by the transmitter, at least one value of CSI reference signal received power (CSI-RSRP) derived by the receiver based on the second set of CSI-RS;
determining, by the transmitter, based on the at least one value of CSI, a precoder for precoding data; and
configuring, by the transmitter, the first set of CSI-RS patterns based on the at least one value of CSI-RSRP.

8. The method of claim 7, further comprising:
sending, by the transmitter, configuration of at least one CSI-RS pattern to the receiver; wherein the at least one CSI-RS pattern comprises the first set of CSI-RS patterns and the second set of CSI-RS patterns.

9. The method of claim 8, the configuration comprises a CSI measurements flag for each CSI-RS pattern; wherein
the first set of CSI-RS comprises the first set of CSI-RS patterns for which the RLM measurements flag takes value 1;
the second set of CSI-RS comprises the second set of CSI-RS patterns for which the RLM measurements flag takes value 1 and value 0; and
the CSI measurements flag with value 1 indicates that the receiver takes CSI measurements.

10. The method of claim 8, the configuration comprises a CSI measurement flag for each CSI-RS pattern and a radio resource management (RRM) flag for each CSI-RS pattern; wherein
the first set of CSI-RS comprises the first set of CSI-RS patterns for which the CSI measurement flag takes value 1;
the second set of CSI-RS comprises the second set of CSI-RS patterns for which the RRM flag takes value 1;
the CSI measurements flag with value 1 indicates that the receiver takes CSI measurements; and
the RRM measurement flag with value 1 indicates that the receiver takes RRM measurements of CSI-RSRP.

11. The method of claim 10, further comprising:
sending, by the transmitter, a third set of CSI-RS to the receiver; wherein
the third set of CSI-RS comprises a third set of CSI-RS patterns for which the RRM measurements flag and the CSI measurements flag take value 0, and a CSI-RS of the third set of CSI-RS is used by the receiver for rate matching a physical downlink shared channel (PDSCH) around resource elements occupied by the CSI-RS of the third set of CSI-RS.

12. A receiver for channel measurements for coordinated multipoint transmission in a wireless communication system, comprising:
a processor module, configured to:
obtain a first set of channel state information reference signals (CSI-RS) and a second set of CSI-RS from a transmitter;
derive at least one value of channel state information (CSI) based on the first set of CSI-RS;
derive at least one value of CSI reference signal received power (CSI-RSRP) based on the second set of CSI-RS; and
send the at least one value of CSI and the at least one value of CSI-RSRP to the transmitter.

13. The receiver of claim 12, the processor module is further configured to:
receive configuration of at least one CSI-RS pattern from the transmitter;
receive at least one CSI-RS transmitted by the transmitter according to the at least one CSI-RS pattern; and
obtain the first set of CSI-RS and the second set of CSI-RS from the received at least one CSI-RS according to the configuration.

14. The receiver of claim 13, the configuration comprises a CSI measurements flag for each CSI-RS pattern; wherein
the first set of CSI-RS comprises a first set of CSI-RS patterns for which the CSI measurements flag takes value 1; the second set of CSI-RS comprises a second set of CSI-RS patterns for which the CSI measurements flag takes value 1 and value 0; and
the CSI measurements flag with value 1 indicates that the receiver takes CSI measurements.

15. The receiver of claim 13, the configuration comprises a CSI measurement flag for each CSI-RS pattern and a radio resource management (RRM) flag for each CSI-RS pattern; wherein
the first set of CSI-RS comprises a first set of CSI-RS patterns for which the CSI measurement flag takes value 1;
the second set of CSI-RS comprises a second set of CSI-RS patterns for which the RRM flag takes value 1;
the CSI measurements flag with value 1 indicates that the receiver takes CSI measurements; and
the RRM measurement flag with value 1 indicates that the receiver takes RRM measurements of CSI-RSRP.

16. The receiver of claim 15, the processor module is further configured to obtain a third set of CSI-RS; wherein
the third set of CSI-RS comprises a third set of CSI-RS patterns for which the RRM measurements flag and the CSI measurements flag take value 0; and
a CSI-RS of the third set of CSI-RS is used by the receiver for rate matching a physical downlink shared channel (PDSCH) around resource elements occupied by the CSI-RS of the third set of CSI-RS.

17. A transmitter for channel measurements for coordinated multipoint transmission in a wireless communication system, comprising:
a processor module, configured to:
send a first set of channel state information reference signals (CSI-RS) according to a first set of CSI-RS patterns and a second set of CSI-RS according to a second set of CSI-RS patterns, to a receiver;
receive at least one value of channel state information (CSI) derived by the receiver based on the first set of CSI-RS;
receive at least one value of CSI reference signal received power (CSI-RSRP) derived by the receiver based on the second set of CSI-RS;
determine a precoder for precoding data based on the at least one value of CSI; and
configure the first set of CSI-RS patterns based on the at least one value of CSI-RSRP or the at least one value of RSS.

18. The transmitter of claim 17, the processor module is further configured to:
send configuration of at least one CSI-RS pattern to the receiver; wherein the at least one CSI-RS pattern comprises the first set of CSI-RS patterns and the second set of CSI-RS patterns.

19. The transmitter of claim 18, the configuration comprises a CSI measurements flag for each CSI-RS pattern; wherein
the first set of CSI-RS comprises the first set of CSI-RS patterns for which the CSI measurements flag takes value 1;
the second set of CSI-RS comprises the second set of CSI-RS patterns for which the CSI measurements flag takes value 1 and value 0; and
the CSI measurements flag with value 1 indicates that the receiver takes CSI measurements.

20. The transmitter of claim 18, the configuration comprises a CSI measurement flag for each CSI-RS pattern and a radio resource management (RRM) flag for each CSI-RS pattern; wherein
the first set of CSI-RS comprises the first set of CSI-RS patterns for which the CSI measurement flag takes value 1;
the second set of CSI-RS comprises the second set of CSI-RS patterns for which the RRM flag takes value 1;
the CSI measurements flag with value 1 indicates that the receiver takes CSI measurements; and
the RRM measurement flag with value 1 indicates that the receiver takes RRM measurements of CSI-RSRP.

21. The transmitter of claim 20, the processor module is further configured to:
send a third set of CSI-RS to the receiver; wherein
the third set of CSI-RS comprises a third set of CSI-RS patterns for which the RRM measurements flag and the CSI measurements flag take value 0; and
a CSI-RS of the third set of CSI-RS is used by the receiver for rate matching a physical downlink shared channel (PDSCH) around resource elements occupied by the CSI-RS of the third set of CSI-RS.
